(19) United States
(12) Patent Application Publication
(10) Pub. No.: US 2003/0083898 A1
(43) Pub. Date: May 1, 2003

(54) System and method for monitoring intellectual capital

(76) Inventors: Corey W. Wick, Lewisville, TX (US); Gary L. Knight, Plano, TX (US); Michael Gardner, Derby (GB); Karen E. Kostohryz, McKinney, TX (US); Stephen C. Dorfmeister, McKinney, TX (US); James A. Varnell, Frisco, TX (US); Henry W. Rhodes, Richardson, TX (US); William L. Casey, Flower Mound, TX (US)

Correspondence Address: BAKER BOTTS L.L.P., 2001 ROSS AVENUE, SUITE 600, DALLAS, TX, 75201-2980, US

(21) Appl. No.: 10/261,389

(22) Filed: Sep. 30, 2002

Related U.S. Application Data
(63) Continuation-in-part of application No. 10/029,657, filed on Dec. 20, 2001.
(60) Provisional application No. 60/257,676, filed on Dec. 22, 2000.

(51) Int. Cl. G06F 17/60

(52) U.S. Cl. 705/1

(57) ABSTRACT

A system for monitoring intellectual capital includes a metrics engine and a dashboard. The metrics engine is operable to receive a request associated with a metric, identify data associated with the request, retrieve data based on the identified data and process the data based on the requested metric. The dashboard is operable to graphically display the provided data.

### RELATED APPLICATIONS

This application is a continuation-in-part of U.S. application Ser. No. 10/029,659 filed Oct. 20, 2001 by Donna M. Stemmer, Mike Gardner and Corey W. Wick entitled Balance Sheet and Method for Measuring Intellectual Capital, which application claims the priority under 35 U.S.C. §119 of U.S. Provisional Application Serial No. 60/257,676 filed Dec. 22, 2000 entitled Invisible Balance Sheet.

### TECHNICAL FIELD OF THE INVENTION

The present invention relates generally to measuring market value and, more particularly, to a system and method for monitoring intellectual capital.

### BACKGROUND OF THE INVENTION

Businesses today are showing large discrepancies between their market price and their financial assets (as defined in their financial balance sheet). Many businesses have share values that considerably outweigh their physical or financial assets, and this phenomenon has continued despite the crash of dot-com companies and an extended bear market. In essence, the market realizes that the value of a company involves far more than its physical and financial assets.

A business's market value includes its financial capital and its intellectual capital. Financial capital is measured and controlled by traditional accounting practices and standards. However, intellectual capital, which is a significant percentage of a business's market value, is typically undefined and unmanaged.

In a study by Karl Erik Sveiby, as discussed in his book “The New Organizational Wealth,” it was determined that businesses high in intellectual capital outperformed their peers in value creation by a margin of 50 percent. Karl Erik Sveiby, The New Organizational wealth, Berrtt-Koehler (1988). The business's shareholder value increased at an average annual rate of 22.2 percent, compared with 14.7 percent for companies focused solely on profit growth and negative 1 percent for businesses seeking revenue growth. Id. at 8. The study also found that a balanced strategy that managed both intellectual capital and financial capital produced increased revenue growth by an average annual rate of 19.2 percent, higher than the 14.6 percent annual rate for businesses actually practicing a revenue growth strategy. Id. at 8.

### SUMMARY OF THE INVENTION

The present invention provides a system and method for monitoring intellectual capital. In a particular embodiment, the present invention uses intellectual capital benchmarking to enable a business to quantitatively and qualitatively measure and monitor its intellectual capital.

In an example embodiment, a method for monitoring intellectual capital includes receiving a request specifying at least one metric. Data associated with the at least one metric is identified and retrieved. The retrieved data is processed based at least in part on the specified metric. The processed data is graphically displayed.

In another embodiment, a system for monitoring Intellectual Capital includes a metrics engine and a dashboard. The metrics engine is operable to receive a request associated with a metric, identify data associated with the request, retrieve data based on the identified data and process the data based on the requested metric. The dashboard is operable to graphically display the provided data.

Technical advantages of one or more embodiments of the present invention include allowing a business or business unit to make balanced business decisions based on intellectual capital as well as financial capital. These balanced business decisions include increasing staff happiness and decreasing staff turnover through proper training and development. Other advantages include exploiting the benefits of a business's intellectual capital, meeting emerging governmental requirements, and improving its overall financial performance and stock price as a result. Furthermore, at least one embodiment of the present invention allows management personnel to further define the intellectual property of the business.

Another technical advantage of one embodiment of the present invention includes providing an intellectual capital dashboard. The intellectual capital dashboard allows users to view various combinations of intellectual capital throughout an organization, create new measurement metrics, and compare intellectual capital components to benchmarks and to subdivisions within the organization. Thus, a user may monitor the development or retention of intellectual capital within an organization and identify subdivisions within the organization that may require attention. In turn, this intellectual capital management capability improves future financial performance since intellectual capital is a leading indicator of future earnings and profitability.

The various embodiments of the present invention may each include some, all, or none of the aforementioned technical advantages. Other technical advantages of the present invention will be readily apparent to one skilled in the art from the following figures, description, and claims.

### BRIEF DESCRIPTION OF THE DRAWINGS

For a more complete understanding of the present invention and its advantages, reference is now made to the following descriptions, taken in conjunction with the accompanying drawings, in which:

FIG. 1 is a block diagram illustrating intellectual capitals in accordance with the prior art;

FIG. 2 is a block diagram illustrating categories of the intellectual capitals in accordance with one embodiment of the present invention;

FIG. 3 is a radar diagram illustrating a method of measuring intellectual capital in accordance with one embodiment of the present invention;

FIG. 4 is a radar diagram illustrating a method of measuring intellectual capital in accordance with one embodiment of the present invention;

FIG. 5 is a flow diagram illustrating a method of measuring intellectual capital in accordance with one embodiment of the present invention;

FIG. 6 is a block diagram illustrating a system for monitoring intellectual capital in accordance with one embodiment of the present invention; and

FIG. 7 is a flow diagram illustrating a method for monitoring intellectual capital in accordance with one embodiment of the present invention.

### DETAILED DESCRIPTION OF THE INVENTION

FIG. 1 illustrates Intellectual Capital 25 in accordance with the prior art. Intellectual Capital 25 is knowledge having value to a business or business unit, including the tacit knowledge embedded in people, processes, and clients. The business's Market Value 15 is substantially the sum of Financial Capital 20 and Intellectual Capital 25. In one embodiment, Intellectual Capital 25 may be subdivided into Human Capital 30, Structural Capital 35, and External Capital 40. As an example, the value of the business's Intellectual Capital 25 might be a result of the data from Human Capital 30, Structural Capital 35, and External Capital 40. It will be understood that the term intellectual capital will include Intellectual Capital 25 and/or one or more of Human Capital 30, Structural Capital 35, and External Capital 40.

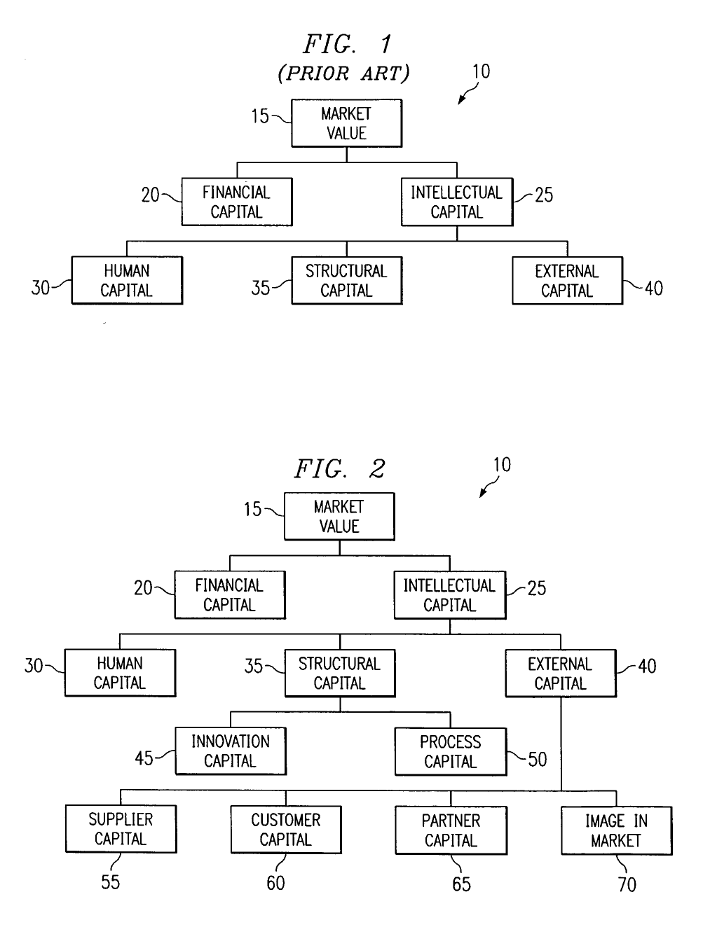

FIG. 2 illustrates the sub-categories of the intellectual capitals of FIG. 1 in accordance with one embodiment of the present invention.

Human Capital 30 includes the capabilities of individuals required to provide solutions to customers. In one embodiment, Human Capital 30 refers to the knowledge, talents, expertise, and problem-solving ability of the business's or business unit's staff. It also may include measurements for experience, training, competence, and the leveragability and stability of the workforce. Furthermore, Human Capital 30 may refer to the size of the staffs' social networks. For example, the social network may include professional relationships and the strength of those relationships. In another example, the business may quantify leadership qualities of its management team. This may include assigning a value to leadership skills. It will be understood that some types of knowledge and expertise are tacit. Human Capital 30 measurements may be an indicator of the business's ability to generate innovative solutions to complex problems. It will be understood that there may be additional reasons to quantify the business's Human Capital 30.

Structural Capital 35 includes the experience and expertise of the organization embedded in processes, policies and systems, such as codification/transfer of knowledge and enabling infrastructure. Structural Capital 35, in the intellectual capital sense, is separate, and generally considered to be distinct, from tangible structural capital, which may include such things as property, plant, and equipment. Structural Capital 35 might represent the quality and revenue-producing capability of the business's processes, procedures, and practices. Structural Capital 35 may add value to the abilities and productivity of its personnel. For example, a recent college graduate may be more valuable and productive at a business with less Structural Capital 35 (a start-up business, for example). Structural capital may be explicit and contained within intellectual assets.

External Capital 40 includes the value of the business's relationships with other entities such as, for example, other companies with whom it does business. External Capital 40 may include understanding customer and supplier visions, values, and requirements. In one embodiment, External Capital 40 is quantified by the value added to the business from external sources. For example, the business's brand image, or its reputation among current and potential customers and suppliers, may allow the business to command higher premiums for its services. The business's customers and suppliers and the strength and length of the relationships may reflect the long-term viability of the business.

Structural Capital 35 includes Innovation Capital 45 and Process Capital 50. Innovation Capital 45 may include the value of intellectual property, such as patents, licenses and royalty streams, the value of white papers, and the ability to create new products and services. In one embodiment, Process Capital 50 is a quantification of knowledge being passed around the business. Process Capital 50 may include the business's investment in internal structures, including information technology (IT) and other knowledge-sharing facilities, and volume of email transmitted internally.

External Capital 40 includes Supplier Capital 55, Customer Capital 60, Partner Capital 65, and Image in Market 70. Supplier Capital 55 may include the satisfaction of the supplier, customer satisfaction with the supplier, and the business's satisfaction with the supplier. Each of these may be measured and scaled to represent one median number. For example, a poll may be sent to the business customers in regards to a supplier resulting in a satisfaction index that may be compared to a satisfaction index performed by the business's individual business units.

Customer Capital 60 may include competence enhancing customers, which may be a number of customers that receive a certain score on a series of questions posed to the business's staff. For example, one question may ask the staff member if the customer is willing to give referrals. Another question may attempt to determine if the customer provides high profit projects. Partner Capital 65 may include a partner satisfaction index or a satisfaction with partner index. Alternatively, Partner Capital 65 may include any other measure that may assist the business or business unit in assigning a value to Partner Capital 65. Image in Market 70 preferably includes market analysis ratings or the value of the business's trademarks. Alternatively, Images in Market may include any other measure capable of quantifying the business's Image in Market 70.

Each intellectual capital (Human Capital 30, Structural Capital 35, and External Capital 40), has associated metrics. A given metric may be any quantifiable indicator that may be measured through data gathering or some other method. Furthermore, the metric may be monetary or non-monetary. A monetary metric may include an indicator measured by a dollar value or some other financial measure. A non-monetary metric may include an indicator that is measured by time, volume, poll result, or any other non-financial measure. The metric may also be related to other metrics in order to determine a value for the respective intellectual capital. For example, a subset of metrics may be scaled to one another such that the subset can be represented in a radar diagram or other mathematical computation. An exemplary list of metrics for each intellectual capital and category is included below. It will be understood that the list is not exclusive and is for exemplary purposes only.

1.0 Human Capital 30 Metrics

1.1 Number of Communities of Interest/Affinity Groups Set Up may include a total of discussion groups within the business or business unit.

1.2 Relative Pay Position may include an index of staff pay to outside pay.

1.3 Competency Information

1.3.1 Experience in a Competency Type may include the total number of years for all staff members in the competency type.

1.3.2 Experience of Workforce may include the experience level of staff within the business.

1.4 Personal Performance of Staff

1.4.1 Staff Turnover may include the number of staff leaving the business divided by the total number of employees.

1.4.2 Median Age of Staff in Organization may include the median age of staff in the business or business unit employed during a period.

1.4.3 Succession Planning may include the percentage of managers who developed plans for their successors.

1.4.4 Revenue Generating Staff/Efficiency of Organization may include the number of professionals divided by the total number of staff.

1.4.5 Internal Grading may include the number of staff promoted during a period divided by the total number of staff.

1.4.6 Professional Internal Grading may include the median ratings given to staff by management or peers.

1.4.7 Timely Appraisals may include the number of staff members appraised during a period.

1.4.8 Number of Days Absenteeism may include the number of days absent divided by total number of work days for period.

1.4.9 Mentored Staff may include the number of staff with an assigned mentor/total number of staff.

1.4.10 Social Network Mapping may include the number of staff member contacts within a business unit.

1.4.11 Knowledge Sharer Performance may include the measure of how well a staff member shares knowledge with remaining staff.

1.4.12 Leverage Effect may include the calculation (profit/revenue)×(revenue/number of staff)×(number of staff/number of professional staff).

1.5 Training and Education

1.5.1 Training Investment may include the training costs spent on professionals divided by total revenues.

1.5.2 Education Level per Staff Member may include the median grade of education by staff.

1.5.3 Training Provided may include the number of hours training provided divided by the number of employees.

1.6 Staff Attitudes

1.6.1 Staff Satisfaction Survey may include the overall figure of staff satisfaction.

1.6.2 Staff Referrals may include the number of staff referrals divided by the number of staff positions filled for a period.

1.7 Work Related

1.7.1 Contractor Usage may include the numbers of contractors divided by the number of staff.

1.7.2 Revenue Generating Staff/Efficiency of Organization may include the number of professional staff divided by total number of staff.

1.7.3 Time Not Spent on Productive Work may include the percent of total staff time spent on non-productive work and total staff work time.

1.7.4 Value Added per Staff Member may include the how much value each professional contributes to the business, business unit, or a project.

1.8 Rookie Ratio may include the number of staff with less than two years experience divided by the total number of staff.

1.9 Open Plan Office Space may include the percentage of employees in an open office.

2.0 Innovation Capital 45 Metrics

2.1 Communication Internally

2.1.1 Best Practice Shared may include the number of best practices made available to staff.

2.1.2 Usage of Best Practices may include the number of best practices shared by staff members.

2.1.3 Usage of a Piece of Knowledge may include the number of times that a piece of data is retrieved from a repository.

2.1.4 New Ideas Generated may include the total number of ideas that staff present to management as new.

2.1.5 White Papers Published may include the total number of white papers published in a period.

2.2 Patent Protection

2.2.1 Number of Patents Owned may include the number of patents successfully applied for by the business.

2.2.2 Value of Patents Owned may include the licensing fees received for the patents owned by the business.

2.2.3 Number of Patents Proposed may include the total number of patent ideas suggested by staff, possibly including those not applied for.

2.3 Communication Externally

2.3.1 Published Internal Achievements may include the time spent by staff presenting to external seminars.

2.3.2 Words in Print may include the total number of words printed in external publications by the business.

2.3.3 External Seminar Hosting (Attendance) may include the number of hours of times the number attending an external seminar.

2.3.4 Work Being Done by Academic Bodies may include the dollar value of work being done by academic bodies for the business.

2.4 Delivery to Market

2.4.1 Capabilities to Market may include the number of capabilities that emerge in the marketplace per period.

2.4.2 Services Sold<2 years old may include the total number of services sold within the last two years.

2.4.3 Time to Market may include the amount of time from concept initiation to availability in the marketplace for a product or process.

2.4.4 Investment in own R&D may include the dollar amount spent on research and development divided by the total expenses for the business.

3.0 Process Capital 50 Metrics

3.1 Internal Investment

3.1.1 Investment in Internal Structures may include the total investment in new subsidiaries, methods, and systems divided by total revenues.

3.1.2 Benefits Attributable to Internal Projects may include the dollar value of the actual benefits received by the business as a result of the internal project.

3.1.4 Spend on Internal IT Systems may include the total spent on IT systems divided by total costs of the business.

3.1.5 Spend on Knowledge Sharing Facilities may include the costs attributable to making knowledge available to other staff divided by the total costs of the business.

3.2 Business Improvement

3.2.1 Improvement Suggestions may include the number of improvements suggested by the staff.

3.2.2 Improvement Suggestions Implemented may include the number of improvements suggestions implemented divided by the number of improvements suggested by the staff.

3.3 Collaboration

3.3.1 Time Saved by Leveraging may include the amount of time saved by customers using leveraged projects divided by the total amount of customers.

3.3.2 Time to Market may include the amount of time from concept initiation to availability in the marketplace for a product or process.

3.3.3 Number of Processes Leveraged may include the number of methods transferred from one customer to another.

3.3.4 Number of Projects Leveraged may include the number of projects transferred from one customer to another.

3.3.5 Knowledge Bank may include the value of the business's research, skills, customer lists, and other banks of knowledge.

3.3.6 Potential Cost Savings from Shared Information may include the previous period's usage of shared data.

3.3.7 Potential Increases in Revenue from Shared Information may include the total man hours saved times the value added per professional.

3.4 Tools Support

3.4.1 Volume of Email Passed Around the Company may include the megabytes of email data passed internally.

3.4.2 Number of Different Facilities Used to Access Information may include the total number of systems that are used to hold data.

3.4.3 Tool Availability for Staff may include the number of staff that have the tools available to do their job divided by the total number of employees.

3.4.4 Intranet Accessibility may include the percentage of employees with access to the business's intranet.

3.5 Information Sharing

3.5.1 Potential Cost Savings from Shared Information may include the previous period's usage of shared data.

3.5.2 Information Availability for Staff may include the number of staff that have the information available to do their job divided by the total number of employees.

3.5.3 Completed Documents for Repository may include the numbers of overviews of projects divided by sales opportunities.

3.5.4 Knowledge Sharer Performance may include a poll of mentees concerning the ability of their respective mentors to pass on knowledge.

3.5.5 Documented Processes may include the number of processes of the business that are detailed in specifications.

3.5.6 Documented Templates Available for Sharing may include the number of templates available to staff.

3.6 Delivery Speed and Quality

3.6.1 Number of Processes with Reduced Cycle Time may include the number of processes in which the cycle time has diminished over a period of time.

3.6.2 Rate of Defective Deliverables Provided to Customers may include the number of defects identified in products delivered to customers divided by total number of products delivered.

3.6.3 Time Taken to Resolve a Customer Problem may include the average number of time taken to resolve one customer's problems.

3.6.4 Time Taken to Locate a Resource may include the average time taken to locate a staff member.

3.6.5 Customer Problem Resolution may include the number of problems resolved divided by the total number of problems.

3.6.6 Time Taken to Resolve Customer Problems may include the average number of time taken to resolve all customer problems.

3.7 Others

3.7.1 Working Capital Turns may include the receivables plus inventory minus payables, all divided by a number of periods.

3.7.2 Too Many Chiefs may include the total number of revenues divided by administration costs.

3.7.3 Organizational Knowledge Status Survey may include a poll of staff to determine the present status of the staff's education in a competency group.

3.7.4 Knowledge Management Scorecard may include a poll of management on the status of the business's knowledge banks.

4.0 Supplier Capital 55 Metrics

4.1 Satisfied Supplier Index may include the number of satisfied suppliers divided by the total number of suppliers.

4.2 Customer Satisfaction with Suppliers may include a poll of customers to determine their satisfaction with suppliers.

4.3 Satisfaction with Supplier may include the business's satisfaction with the supplier.

4.4 Success in Leveraging Internal Suppliers to External Markets may include the success in providing business to the business's suppliers through the business's customers.

5.0 Customer Capital 60 Metrics

5.1 Customer Capabilities

5.1.1 Number of Organization Enhancing Customers may include the number of customers providing projects over a period.

5.1.2 Value of Organization Enhancing Customers may include the value of projects given by customers over a period.

5.1.3 Number of Staff Competence Enhancing Customers may include the number of customers that provide projects expanding staff experience.

5.1.4 Number of Competence Enhancing Customers may include a poll of staff to determine their view of customer's enhancement of the staff's experience.

5.1.5 Number of Image Enhancing Customers may include the number of customers that benefit the business's trademark recognition or market analysis rating.

5.1.6 Customer Spend on Staff Competence may include the total amount provided by customers for their own projects, including man hours and dollars.

5.2 Customer Relationships

5.2.1 Win/Loss Index may include the number of successful bids for new business divided the total number of bids for new business.

5.2.2 Customer Spend with Business may include figures for each customer as to how much of their period spending was the business or business unit and it's competitors.

5.2.3 Referencability may include the number of customers willing to refer the business to potential customers.

5.2.4 Proportion of Large Customers may include a ratio of the total of billings from top ten customers divided by the total billings.

5.2.5 Longevity of Customers may include the length of an ongoing relationship with customers in months divided by the total number of customers.

5.2.6 Frequency of Repeat Orders may include the number of customers that provide repeat business divided by the total number of customers.

5.2.7 Value of Repeat Orders may include the total value of orders from repeat customers divided by the total value of orders.

5.2.8 Devoted Customers Ratio may include the number of customers with dealings with the business over five years divided by the total number of customers.

5.2.9 Profitability per Customer may include the profit per customer or profit divided by the total number of customers.

5.2.10 Contract Renewals may include the number of contracts renewed divided total number of contracts up for renewal.

5.2.11 Contract Terminations may include the number of contracts terminated early and the number of contracts not renewed divided by the total number of contracts.

5.2.12 Employees/Customers may include the number of employees divided by the total number of customers.

5.2.13 Time Spent Interfacing with Customer may include the total number of hours that staff spend communicating with the customer for a period.

5.3 Customer Satisfaction

5.3.1 Satisfied Customer Index may include the total number of satisfied customers divided by the total number of customers.

5.3.2 Number of Customer Visits to Company may include the total number of times that a customer or client visits the business's sites.

5.3.3 New Customer Site Reports may include the total number of potential customer visits.

5.3.4 Rate of Defective Deliverables Provided to the Customer may include the total number of deliverables with problems divided by the total number of deliverables.

5.3.5 Customer Problem Resolution may include the total number of problems that a customer has divided by the total number of problems for all customers.

5.3.6 Time Taken to Resolve Customer Problems may include the median time taken to solve customer issues.

6.0 Partner Capital 65 Metrics

6.1 Partner Satisfaction Index may include a poll of satisfaction given to the partners of the business.

6.2 Satisfaction with Partner may include the business's satisfaction with the partner.

6.3 Competence Enhancing Partners may include the amount of work given to the business by the partnership.

7.0 Image Capital Metrics

7.1 Image in Community may include a poll of the community to determine their views on the business.

7.2 Market Analyst Ratings may include the current market analysis rating for the business.

7.3 Knowledge & Experience in Your Industry may include the total number of years spent by staff working in the current competency group.

7.4 White Papers Published may include the total number of white papers published in a period.

7.5 Attendance at External Seminars may include the total number of hours attending external seminars divided by the total number of employees.

7.6 Number of Image Enhancing Customers may include the number of customers that benefit the business's trademark recognition or market analysis rating.

7.7 External Seminar Hosting may include the number of hours of times the number attending an external seminar

7.8 Industry Recognition Awards may include the total number of industry recognition awards given to the staff of the business.

In one embodiment, Human Capital 30 may be quantified using the following formula:

Human Capital 30=((((Average Salary for a Staff Member×Years Experience factor)×Staff Satisfaction factor)×Staff Turnover Rate)×Number of Professionals in Organization)+Knowledge Bank value+Training Investment

It will be understood that the Human Capital 30 calculation may include none, one, some or all of the metrics used in the above exemplary calculation to determine the value of Human Capital. Other metrics used by the business might include “Relative Pay Position,” which is the ratio of staff pay to outside pay, and “Experience in Competency Type,” which is the total number of years in a business unit for all staff of the business.

In one embodiment, a value may be assigned to Structural Capital 35 by summing Innovation Capital 45 and Process Capital 50. For example, to obtain a dollar value for Innovation Capital 45, the business may obtain the dollar value of its patents, or the “Value of Patents” metric. Then, the business may sum the three Process Capital 50 categories of “Internal Investment,” “Collaboration,” and “Information Sharing” and combine the result with the value for Innovation Capital 45.

In one embodiment, a value may be assigned to the External Capital 40 by determining the Customer Capital 60 dollar value, converting the other three capital figures (represented under External Capital 40 in FIG. 2) to percentages, and multiplying the dollar value by these percentages. This provides an External Capital 40 value that may have started as the Average Customer Spend per Annum. The figure may have then been reduced by applying (in effect) percentages where customers are not totally satisfied, not willing to provide references, image of the business in the community is not perfect, or any other customer satisfaction criteria. In another embodiment, the Customer Capital 60 dollar value may be the value of ongoing customer relationships multiplied by the ratio of devoted customers multiplied by the percentage of contract renewals.

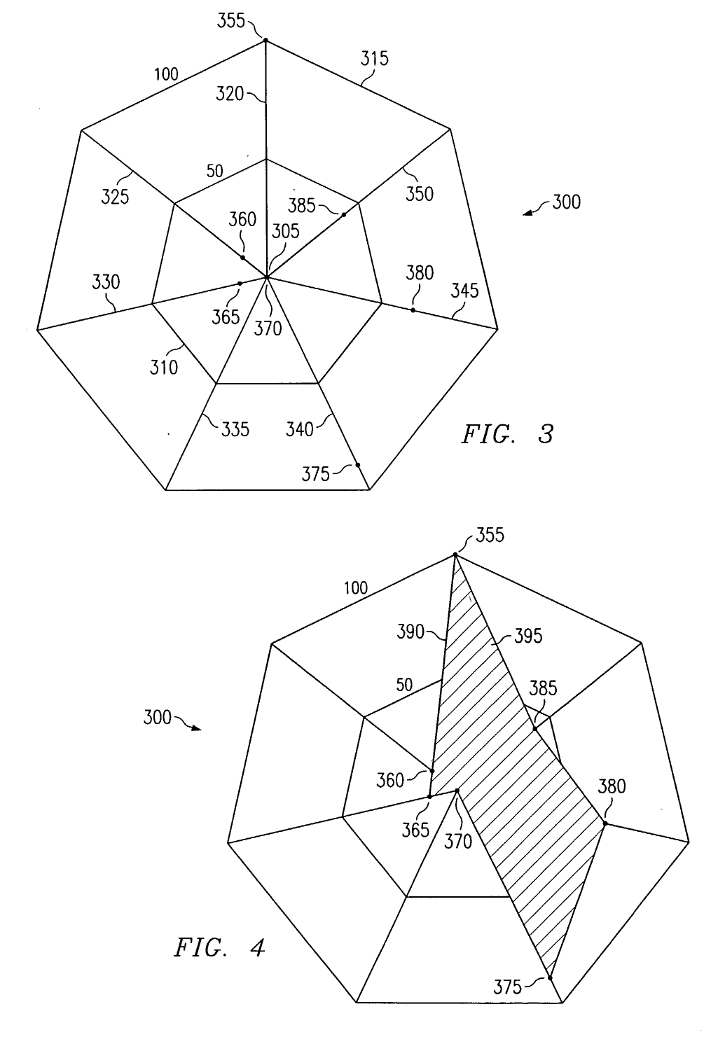

FIG. 3 illustrates a method for measuring Intellectual Capital 25 in accordance with one embodiment of the present invention. In this embodiment, radar diagram 300 includes a plurality of scaled axes 320 to 350 originating from center point 305. For exemplary purposes only, the scales are represented for value 50 at line 310 and value 100 at line 315.

Each scaled axis comprises a metric that has been measured and quantified. Each quantified metric may then be scaled in relation to the other measured metrics. For example, scaled axis 320 may represent a median age of staff, scaled axis 325 may represent a number of mentored staff, scaled axis 330 may represent staff retention rate, scaled axis 335 may represent education level, scaled axis 340 may represent absenteeism rate, scaled axis 345 may represent an overall attitude of staff, and scaled axis 350 may represent a dollar amount spent on training the staff. The exemplary metrics might be measured and quantified in differing manners. For example, scaled axis 340 may be a ratio of median days at work and total work days, while scaled axis 350 may be a dollar amount. Therefore, each axis is scaled so that it may be represented as a value similar to the other quantified metrics. Once the axes are scaled, the respective value for each axis is plotted. For example, point 355 may represent the scaled median age of the staff, along the appropriate axis.

FIG. 4 further illustrates the radar diagram 300 of FIG. 3 measuring Intellectual Capital 25 in accordance with one embodiment of the present invention. Once all of the points 355 to 385 are plotted on the respective scaled axes, the Intellectual Capital 25 may be quantified. In this embodiment, a line 390 connects each point 355 to 385, resulting in an inner region 395. An area of region 395 is then computed. The area of region 395 provides the business or business unit a value of the quantified Intellectual Capital 25 and the ability to monitor changes in the Intellectual Capital 25. For example, if the education level of a business's staff rises, the point 370 moves outwardly along scaled axis 335 causing the area of region 395 to increase. This may represent a rise in the worth of the business's Human Capital 30.

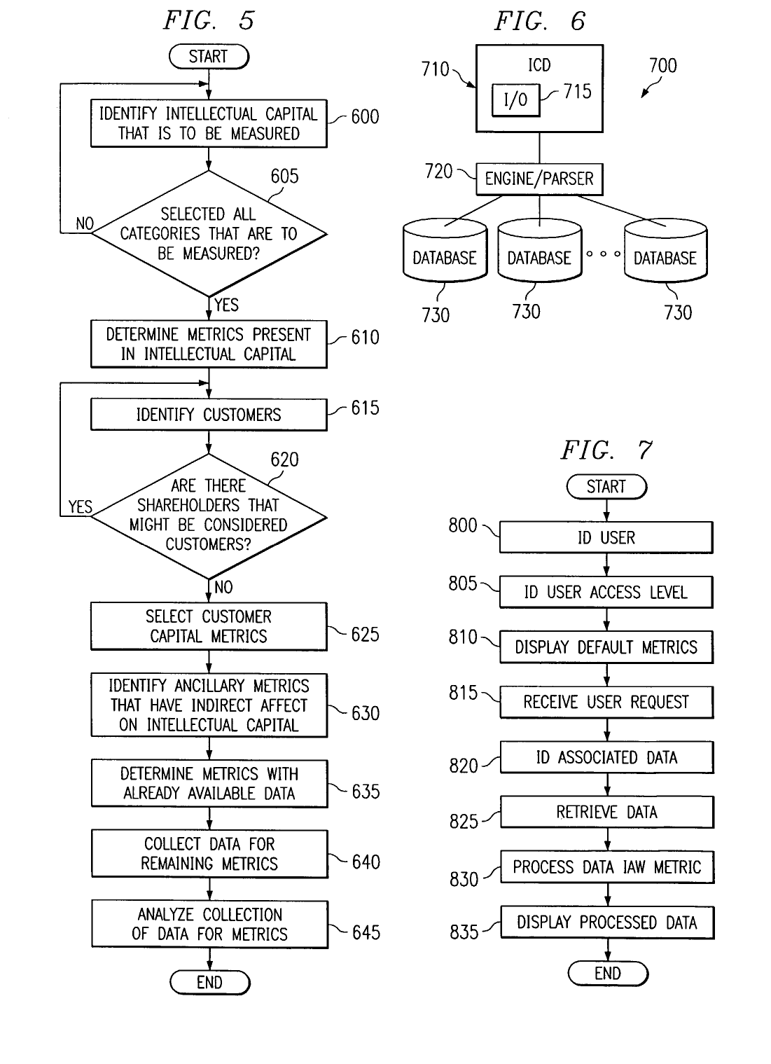

FIG. 5 is a flow diagram illustrating a method for measuring Intellectual Capital in accordance with one embodiment of the present invention. At step 600, the key functionality is examined for the business or business unit. For example, a business that relies on delivering facilities to their customers (e.g., oil or gas industries) might feel that the areas of Structural Capital will be of most importance, while businesses that provide consulting services to their customers may determine that Human Capital is key. It also may be appropriate to select more than one capital and then identify a set of key factors from each of the capitals as important to the business or business unit. In another example, the business or business unit may produce applications, develop IS/IT infrastructure, or solve customer problems. The business may then need to measure Structural Capital (such as processes and procedures) and Human Capital (such as the experience and learning of developers).

In decisional step 605, it is determined whether all the categories that are desired are included in the one or more Intellectual Capitals identified in step 600. Furthermore, not every category of the Intellectual Capital need be measured. For example, if the identified Intellectual Capital is External Capital, then the business or business unit might measure the number of contract terminations, which is included in the Customer Capital category. However, the business may not have any suppliers. Therefore, in this example, the Supplier Capital category would not be needed.

Having defined the Intellectual Capital at step 600 and the categories to be measured at step 605, the metrics that govern the selected intellectual capitals are determined at step 610. In one embodiment, the business first identifies metrics that might influence the overall performance of the business and then selects metrics that influence the performance of the business. For example, staff turnover may be a key metric that influences the performance of a human resources department. It will be understood that there is no minimum or maximum number of metrics appropriate for the business. Each business may be different and, therefore, might identify and select different metrics.

At step 615, the business identifies its customers. The customers might include clients of the business, other internal departments, and governmental entities. Stakeholders within the business might also be considered customers. Thus, at step 620, the business might determine that one or more shareholders are customers for the purpose of determining the value of the identified Intellectual Capitals. Even an internal client might be a customer to the business or business unit. For example, one customer might be the business itself, as it will increase Customer Capital by delivering quality services, on time and under budget. This might result in satisfied customers who will renew contracts, provide more challenging assignments, and increase spending with the business. If the shareholder might be considered a customer, then the method returns to step 615. Otherwise, it proceeds to step 625.

The list of Customer Capital metrics that were selected in step 610, if any, are refined at step 625 to adequately reflect a value based on the selected customers and shareholders. Next, at step 630, any remaining ancillary metrics are selected. An ancillary metric might be any metric that has an indirect effect on the identified Intellectual Capital. For example, if the business wants to extend the capability of its staff then it may want to focus on particular customers to provide a challenge and develop the business further.

At step 635, the business considers what data is available. The available data is then applied to the appropriate selected metrics. Next, data is collected to suitably quantify the remaining metrics at step 640. Once the metrics have been quantified, the business may analyze the collection of selected metrics and determine an overall value for the identified Intellectual Capital.

FIG. 6 illustrates an Intellectual Capital Monitoring system 700 for monitoring the identified Intellectual Capital and various metrics quantified by the method of FIG. 5 in accordance with one embodiment of the present invention. Intellectual Capital Monitoring system 700 includes Intellectual Capital dashboard 710, metrics engine/parser 720, and a plurality of databases 730.

Intellectual Capital dashboard 710 is coupled to engine/parser 720 and is operable to receive information from engine/parser 720 and to generate display information representing the various metrics and Intellectual Capital quantified by the method of FIG. 5. Intellectual Capital dashboard 710 includes input/output module 715. Input/output module 715 is operable to display information to a user based on user input and/or information received from engine/parser 720, receive information from a user, and receive information from engine/parser 720.

Engine/parser 720 is coupled to Intellectual Capital dashboard 710 and data bases 730 and is operable to receive requests for information from Intellectual Capital dashboard 710, gather information from data bases 730 based on the request for information and pre-defined or user-defined metrics, process information based on pre-defined or user-defined metrics, and send information to Intellectual Capital dashboard 710 based on the information gathered from data bases 730.

Data bases 730 are coupled to engine/parser 720 and are operable to store information. Data bases 730 may store any type of information, for example, qualitative and/or quantitative information, and are operable to associate groups of information to each other and to other groups. Data bases 730 may store data in a variety of suitable formats. Engine/parser 720 is operable to retrieve data from data bases 730 in whichever format the data is stored, convert the data to a common format, and process the data in the common format. Data bases 730 may be located at a common site, a group of sites, in disparate locations, or otherwise suitably located.

Intellectual Capital dashboard 710, input/output module 715, engine/parser 720 and data bases 730 may comprise logic embedded in media. The logic comprises functional instructions for carrying out programmed tasks. The media comprises computer disks or other suitable computer-readable media, application specific integrated circuits (ASIC), field programmable gate arrays (FPGA), digital signal processors (DSP), or other suitable specific or general purpose processors, transmission media, or other suitable media in which logic may be encoded and utilized. A computer or computers may also be used in operation of the system 700.

FIG. 7 illustrates a method for monitoring Intellectual Capital in accordance with one embodiment of the present invention. The method begins at step 800 wherein a user is identified. The user may be identified by employee number, computer number, thumbprint, or any other suitable means for associating a user with a particular identification.

Next, at step 805, the user's access level is determined. In one embodiment, the user's access level may be based on the user's position within a hierarchy of the organization. The user's access level may determine which metrics and Intellectual Capital data the user may receive. In one embodiment, the top executives may receive and manipulate all of the organization's metrics and Intellectual Capital data, while lower level executives may only view the metrics and Intellectual Capital data related to their departments. Other suitable access levels and subdivisions of accessible data may be employed.

Next, at step 810, a default set of metrics and Intellectual Capital data is displayed to the user. In one embodiment, this may include a high-level summary of all of the major subdivisions of metrics data, a user-defined list of selected metrics, a list of quick links to other data sets, a list of news items, a list of alerts based on pre-defined metrics baselines, and/or other data are desired by the organization or user. In one embodiment, the default data is selected by the user to provide a summary of the most important metrics or data without further request by the user.

Next, at step 815, user input is received. The user input may be a request for further data, a request to input data, a request to initiate a new metric, a request to compare subsets of metrics and/or data, and/or any other suitable request or input. As described in more detail above, Intellectual Capital Monitoring system 700 of FIG. 6 is operable to provide a wide variety of informational displays to users. For example, in one embodiment, Intellectual Capital Monitoring system 700 may display a comparison of actual metrics value to a pre-defined benchmark or target value. Furthermore, a color-coding system may be employed. For example, if the actual metric value is more than ten percent above or below the target metric value, the actual metric value may be displayed to the user in a red color. If the actual metric value is between three and ten percent above or below the target metric value, the actual metric value may be displayed to the user in a yellow color. If the actual metric value is less than three percent above or below the target metric value, the actual metric value may be displayed to the user in a green color. Other color-coding schemes may also be employed.

Next, at step 820, specific data associated with the user request is identified. At next step 825, the identified data is retrieved. As described above, the identified data may be in a variety of formats and located in one or more disparate databases.

Next, at step 830, the retrieved data is processed in accordance with the designated metric. As described above, the designated metric may include pre-defined or default metrics, user-defined or custom metrics, either stored or provided by the user as input, primary and secondary metrics, and/or other suitable combinations of metrics and data.

Next, at step 835, metrics and/or Intellectual Capital data is displayed to the user based on the input received in step 815. As described in more detail above, Intellectual Capital Monitoring system 700 is operable to receive data from a wide variety of sources and databases, to compile the data based on pre-defined or user-input metrics, and to display the data based on pre-defined or user-input preferences. At step 835, the appropriate metric and/or data is displayed to the user based on the user input and the process ends.

Although the methods of FIGS. 5 and 7 have been described as specific steps in a specific order, various steps may be omitted, added, or performed in a different order as desired in keeping with the spirit of the present invention. For example, steps 815 and 820 of FIG. 7 may be repeated as desired by the user without requiring steps 800 and 810 be repeated as well. Alternatively, steps 815 and 820 may be repeated until a pre-defined time period has elapsed, after which the user will be identified again (via steps 800 and 805) to improve security. Other suitable combinations may also be employed.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶6 of 35 U.S.C. §112 as it exists on the date of filing hereof unless “means for” or “step for” are used in the particular claim.

What is claimed is:

1. A system for monitoring intellectual capital, comprising:
a metrics engine, operable to receive a request specifying at least one metric, identify data associated with the at least one metric, retrieve the identified data, and process the retrieved data based at least in part upon the metric; and
a dashboard operable to graphically display the processed data.

2. The system of claim 1, wherein the metrics engine comprises a memory and the memory comprises default metrics.

3. The system of claim 1, wherein the metrics engine comprises a memory and the memory comprises custom metrics.

4. The system of claim 3, wherein the custom metric is based on contemporaneously provided user input.

5. The system of claim 1, wherein the metric comprises at least one primary metric.

6. The system of claim 5, wherein the primary metric comprises at least one secondary metric.

7. The system of claim 6, wherein the retrieved data is associated with at least one secondary metric.

8. The system of claim 1, wherein the identified data comprises a first portion in a first format and a second portion in a second format.

9. The system of claim 8, wherein the metrics engine is further operable to retrieve the first portion of data in the first format and the second portion of data in the second format and to process the first and second portions in a third format.

10. The system of claim 1, further comprising:
a first database operable to store a first portion of the identified data in a first format; and
a second database operable to store a second portion of the identified data in a second format.

11. The system of claim 10, wherein the metrics engine is further operable to retrieve the first portion of the identified data from the first database in the first format, retrieve the second portion of the identified data from the second database in the second format, and convert the first and second portions into a third format.

12. The system of claim 10, wherein the metrics engine is further operable to receive data based on user input and to store data in the first database in a first format.

13. The system of claim 1, wherein the metrics engine is further operable to receive at least a portion of the identified data from user input and to process the received data based at least in part on the metric.

14. The system of claim 1, wherein the identified data is qualitative data and the metrics engine is further operable to quantify the qualitative data.

15. A method for monitoring intellectual capital, comprising:
receiving a request specifying at least one metric;
identifying data associated with the at least one metric;
retrieving the identified data;
processing the retrieved data based at least in part on the specified metric; and
graphically displaying the processed data.

16. The method of claim 15, wherein the metric comprises default metrics.

17. The method of claim 15, wherein the metric comprises custom metrics.

18. The method of claim 17, wherein the custom metric is based on contemporaneously provided user input.

19. The method of claim 15, wherein the metric comprises at least one primary metric.

20. The method of claim 19, wherein the primary metric comprises at least one secondary metric.

21. The method of claim 20, wherein the retrieved data is associated with at least one secondary metric.

22. The method of claim 15, wherein the identified data comprises a first portion in a first format and a second portion in a second format.

23. The method of claim 22, wherein the first portion of the identified data is retrieved in a first format, a second portion of the identified data is retrieved in a second format, and the first and second portions are processed in a third format.

24. The method of claim 15, further comprising storing a first portion of the identified data in a first format and a second portion of the identified data in a second format.

25. The method of claim 24, further comprising receiving user data based on user input and storing the user data in a first database in a first format.

26. The method of claim 15, further comprising receiving at least a part of the identified data from user input and processing the identified data at least in part based on the specified metric.

27. The method of claim 15, further comprising:
identifying a user;
identifying a user access level based on the identified user; and
processing the identified data based at least in part on the user access level.

28. The method of claim 15, wherein the identified data is qualitative data and processing the retrieved data further comprises quantifying the qualitative data.
